(19) United States
(12) Patent Application Publication
(10) Pub. No.: US 2017/0269817 A1
(43) Pub. Date: Sep. 21, 2017

(54) INFORMATION PROCESSING METHOD AND ELECTRONIC DEVICE

(71) Applicant: Lenovo (Beijing) Limited, Beijing (CN)

(72) Inventor: Qi Hua Xiao, Beijing (CN)

(21) Appl. No.: 15/464,692

(22) Filed: Mar. 21, 2017

(30) Foreign Application Priority Data
Mar. 21, 2016 (CN) 201610161970.9

(51) Int. Cl. G06F 3/0481; G06F 3/0488; G06F 3/14

(52) U.S. Cl. CPC G06F 3/04817; G06F 3/1423; G06F 3/0488; G06F 3/04845

(57) ABSTRACT

One embodiment provides a method, comprising: detecting, using a processor, a first user operation upon one of a plurality of displays operative connected to an information handling device; and controlling, using a processor, the one of a plurality of displays to display thereupon a first window associated with the first user operation; wherein the first user operation may be performed upon any of the plurality of displays. Other aspects are disclosed and claimed.

### CLAIM FOR PRIORITY

This application claims priority to Chinese Application No. 201610161970.9, filed on Mar. 21, 2016, which is fully incorporated by reference herein.

### FIELD

The subject matter described herein relates to the field of information technologies, and in particular to an information processing method and an electronic device.

### BACKGROUND

Some operating systems support multi-screen display, for example, Windows 10. Information such as a taskbar, a start menu and the like can be displayed on every screen. A certain task started according to a user indication may only be displayed on a default screen. In the process of multi-screen display, a situation often arises in which an application is opened but displayed on another screen, and then a user needs to manually drag the application from another screen.

### BRIEF SUMMARY

In summary, one embodiment provides a method, comprising: detecting, using a processor, a first user operation upon one of a plurality of displays operative connected to an information handling device; and controlling, using a processor, the one of a plurality of displays to display thereupon a first window associated with the first user operation; wherein the first user operation may be performed upon any of the plurality of displays.

Another aspect provides an electronic device, comprising: a detection unit that detects a first user operation acting upon one of a plurality of displays operatively connected to the electronic device; and a control unit that controls the one of a plurality of display to display a first window based on the first user operation; wherein the first user operation may be performed upon any of the plurality of displays.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic flow diagram of a first information processing method provided in an embodiment;

FIG. 2A is a schematic diagram of a multi-screen display effect;

FIG. 2B is a schematic diagram of a multi-screen display effect of the information processing method according to an embodiment;

FIG. 3A is a schematic diagram of another multi-screen display effect;

FIG. 3B is a schematic diagram of another multi-screen display effect of the information processing method according to an embodiment;

FIG. 4 is a schematic flow diagram of a second information processing method provided in an embodiment;

FIG. 5 is a schematic structural diagram of an electronic device provided in an embodiment; and

FIG. 6 is a schematic flow diagram of a third information processing method provided in an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

### Embodiment 1

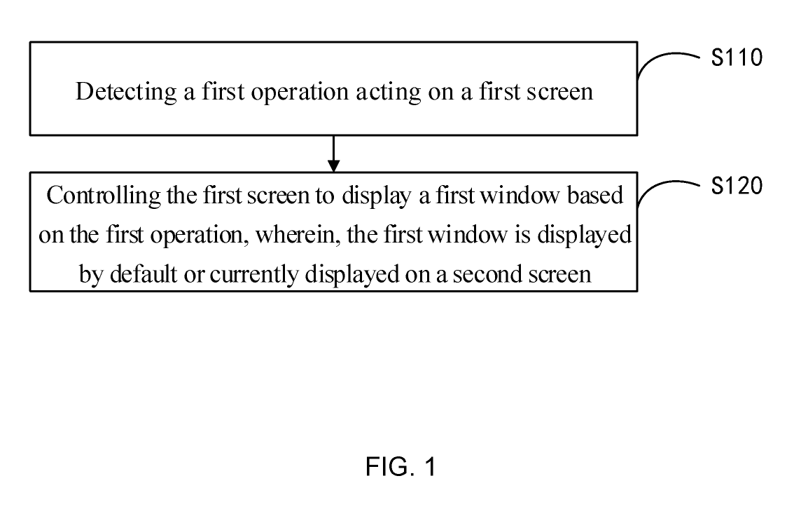

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen.

The information processing method described in this embodiment can be applied to an electronic device having a plurality of screens connected thereto, for example, a desktop computer having at least more than two screens connected thereto. Screen is used interchangeably with display herein. As such, the preceding sentence may also be read as a desktop computer having at least more than two displays connected thereto.

The first operation detected in step S110 is directed to the first screen. For example, a mouse cursor is displayed on the first screen, the first operation is a mouse operation. Step S110 further comprises: detecting a touch or a floating touch acting on the first screen. Certainly, if an input cursor of a keyboard is located on the first screen, a keyboard input is currently detected. All of the above-described mouse operation, keyboard input and touch and floating touch can be considered as the first operation acting on the first screen.

At S120 the first screen to display the first window based on the first operation is controlled. The first window herein is a window that is opened by triggering the first operation. The first window is originally displayed on the second screen by default, or is already currently displayed on the second screen. Since the first operation currently acts on the first screen, a user may be at a viewing location of the first screen, the first screen is required to display the first window. In this embodiment, an electronic device automatically displays the first window on the first screen, avoiding a phenomenon in which the first window is displayed on the second screen by default or retentively displayed on the second screen, such that the user has to drag the first window from the second screen, leading to cumbersome operations, low processing efficiency and low intelligence.

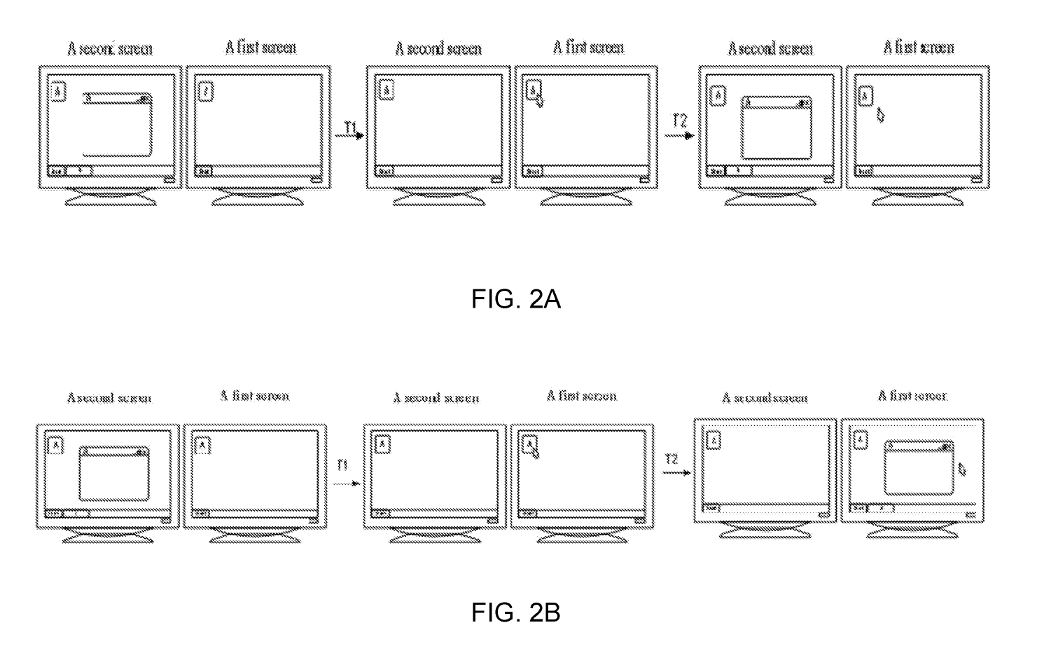

For example, as shown in FIG. 2A, before time T1, a window A is opened on the second screen, and this task, when being reopened, may only be displayed on the first screen. The location of the user changes from a viewing location of the second screen to a viewing location of the first screen. After time T1 and before time T2, the electronic device receives an operation in which a mouse acts on the first screen to open the window A. In the prior art, in response to this operation, after time T2, the window A will be reopened on the second screen for default display. If the window A is required to be displayed on the first screen, the user needs to manually move the window of the task A from the second screen to the first screen. Low operating sensitivity, cumbersome operations and low processing efficiency arises herein. A hollow arrow shown in FIG. 2B can be regarded as an indicative icon of the mouse.

FIG. 2B shows a schematic diagram of the displaying in which the information processing method described by this embodiment is employed; before time T1, a window A is opened on the second screen, and the task, when being reopened, may only be displayed on the first screen. After time T1 and before time T2, an operation acting on the first screen is received, after time T2, a window may be directly opened on the first screen; at this time, obviously, there is no requirement for additional manual operations by the user, which therefore improves intelligence of the electronic device, makes better use of software and hardware resources of the electronic device and increases resource utilization and user satisfaction.

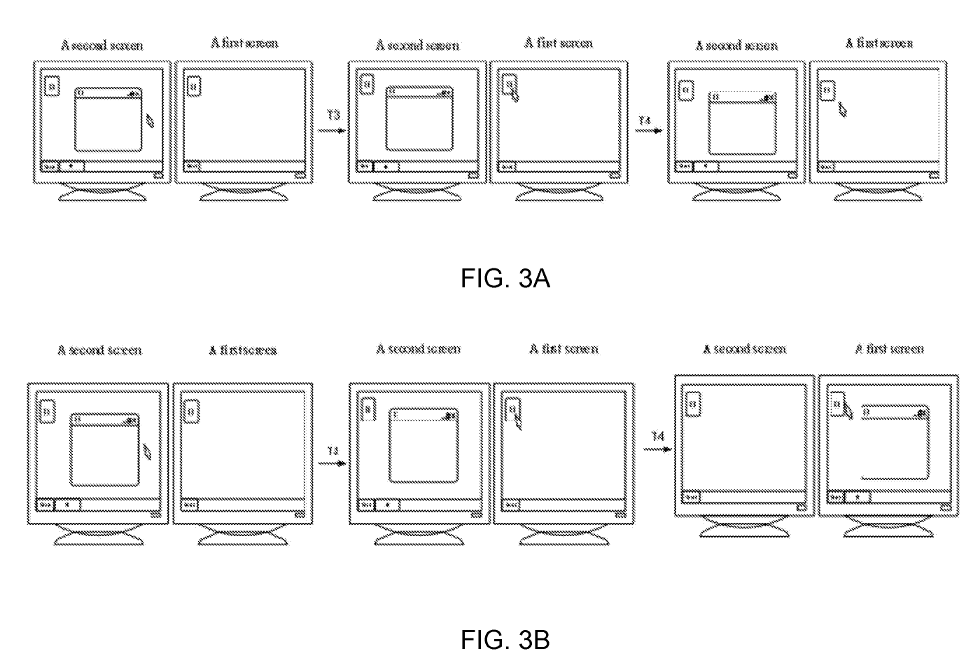

As another example, as shown in FIG. 3A, in the prior art, before time T3, a window B is opened on the second screen, the current location of the user is a viewing location of the first screen, after time T3 and after time T4, the electronic device has detected a user operation acting on an icon corresponding to the window B on the first screen, and in response to a click operation, after time T4, the second screen may be controlled to maintain the displaying of the window B, the user thus cannot see the window B on the first screen.

FIG. 3B shows a schematic view of the displaying based on the information processing method provided by the embodiment; before time T3, a window B is opened on the second screen, the current location of the user is a viewing location of the first screen, after time T3 and after time T4, the electronic device has detected a user operation acting on an icon corresponding to the window B on the first screen, and in response to a click operation, after time T4, the first screen may be controlled to display the window B.

In an embodiment, the user utilizes a mouse to click a social application icon on the first screen, obviously, the operation of clicking the social application icon is the first operation acting on the first screen. The first operation described in this embodiment can be a mouse operation, a keyboard operation, a touch operation, a floating touch operation or the like. The first operation described in this embodiment can be an operation acting on a specified location, for example, an operation acting on a window icon of the first window. If a plurality of window icons of the first window are displayed on the first screen, the first operation can also be a detected operation acting on the window icon of a specified display location. In an embodiment, detection that the operation acts on a window icon on a display taskbar, the electronic device controls the first screen to display the first window, otherwise, if the operation acts on other locations, the electronic device controls the second screen to display the first window. It is obvious that only one example is given here for illustration, but the embodiment is not limited to the above-described example in specific implementations.

In summary, the method provided by this embodiment may control the first screen to display the first window that is responsive to the first operation according to the first screen receiving the first operation, which facilitates viewing by the user and avoids the problem that a window is required to be manually dragged due to the displaying on other screens.

### Embodiment 2

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen. The first window is an unopened window and is displayed on the second screen by default; and the first operation is an opening operation of the first window.

In this embodiment, the first window is a window that is not currently opened, but rather displayed on the second screen by default. For example, if the last displaying of the first window is on the second screen, generally, an operating system will display the first window on the second screen by default when the first window is reopened.

The first operation described in this embodiment is an opening operation for opening the first window. In this embodiment, if the first window is a window of various applications, the first operation can be an opening operation of an activation application or a start application. In this embodiment, the start application is applied to a currently unstarted application such that the application switches from an unstarted status to a started status. The activation application activates an application in a ready status after start in a background so as to run in a foreground.

In this way, the information processing method provided by this embodiment can avoid the phenomenon in which an application is opened on one screen, but displayed on another screen.

### Embodiment 3

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen. The first window is a window currently displayed on the second screen. The step S120 comprises: controlling the first screen to display another first window based on the first operation.

In this embodiment, the first window is a window currently displayed on the second screen. For example, a word document entitled Read the News Every Day is opened on the second screen; certainly, the electronic device detects the opening operation for opening this word document on the first screen. In this embodiment, a brand new first window will be controlled to be displayed on the first screen. For example, a user, at a prior time, makes edits to this word document on the second screen, but did not save it. In this embodiment, a word document opened on the first screen can be a saved word document, and the content displayed on a word window displayed on the first screen does not include newly edited content on the second screen. The first window opened on the first screen can be a window corresponding to this word document before being opened on the second screen, and, the first windows displayed by the two screens are the same document, but different versions of windows generated by the same document at different times.

The first window controlled to be opened in step S120 may be the same window as the first window displayed on the second screen, the same window herein comprises the window type and the content displayed in the window. Taking the foregoing embodiment as a further example, the word document entitled Read the News Every Day is currently displayed on the second screen, and in step S120, another window of this word document entitled Read the News Every Day is controlled to be opened on the first screen. The display content of the two documents opened on the first screen and the second screen is consistent.

This embodiment provides a method, wherein one electronic device, on two display screens connected thereto, can display a window that is displayed on one screen on another window. Thus, a user can open a window that is already opened on a screen that is convenient to be viewed by the user according to his/her own requirements. After performing the method described in this embodiment, two first windows can be seen on the first screen and the second screen, and the content displayed by the two first windows may be exactly the same, or may be partially the same.

### Embodiment 4

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen. The first window is a window currently displayed on the second screen; the step S120 comprises: controlling the first window to switch from the second screen to the first screen for display based on the first operation.

In this embodiment, if the first window is a window currently displayed on the second screen, the first window displayed on the second screen will automatically switch to the first screen for display without the manual dragging of the user. It is obvious that the software and hardware resources of the electronic device are better used and the intelligence of the electronic device is improved. By performing the method provided by this embodiment, after the first window is displayed on the first screen, the second screen will stop the displaying of the first window.

### Embodiment 5

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen.

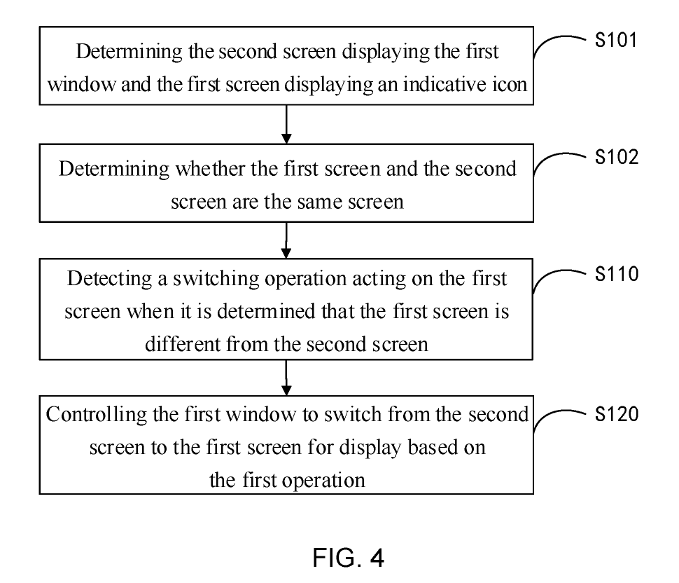

As shown in FIG. 4, before detecting the first operation acting on the first screen, the method further comprises: step S101: determining the second screen displaying the first window and the first screen displaying an indicative icon; step S102: determining whether the first screen and the second screen are the same screen; step S110 comprises: detecting a switching operation acting on the first screen when it is determined that the first screen is different from the second screen; and step S120 comprises: controlling the first window to switch from the second screen to the first screen for display based on the first operation.

In this embodiment, the indicative icon comprises a mouse cursor of a mouse, a keyboard cursor, an indicative icon of touch and similar input. If the first window is currently displayed on the second screen while indication devices such as the mouse are already moved to another location by the user, then the indicative icon of the indication device is already displayed on the first screen.

At this time, the display location of the indicative icon is already changed, the viewing location of the user is also changed, and the screen that is convenient to be viewed by the user is also changed. In this embodiment, in order to solve the problem of viewing inconvenience, a determination will be made as to whether the first screen and the second screen are the same screen. Step S102 described in this embodiment can be performed periodically.

In step S110, when it is determined that the first screen and the second screen are not the same screen, the switching operation acting on the first screen is detected, and the first window will be displayed on the first screen in response to the switching operation in step S120. In this embodiment, a step that the window on the second screen is switched to the first screen for display is included.

The switching operation described in this embodiment can be a click operation, a slide operation acting on a window icon of the first window, or the like. More specifically, the switching operation can be a click operation, a slide operation acting on a window icon of the taskbar, or the like.

When the location of the user is changed, the user is not required to manually drag a window from one screen to another screen, which simplifies user operation and improves the intelligence of the electronic device and the user satisfaction.

### Embodiment 6

As illustrated in FIG. 1, this embodiment provides an information processing method, comprising: step S110: detecting a first operation acting on a first screen; and step S120: controlling the first screen to display a first window based on the first operation, wherein the first window is displayed by default or currently displayed on a second screen, and the first screen is different from the second screen.

The method further comprises: detecting whether a specified type of application on the second screen satisfies a preset display condition; and controlling the second window of the specified type of application satisfying the preset display condition to be displayed on the first screen, wherein the first screen is a screen that displays an indicative device icon or the last screen that receives an indication from a user.

The specified type of application described in this embodiment can comprise interactive applications, such associal applications, common instant communication applications, and further various applications such as e-mails, and the like. The specified type of application may further comprise an internal triggering event application of an electronic device. For example, an alarm set on the second screen.

Satisfying the preset display conditions includes, for example, an interactive application receiving a new message, for example, QQ receiving a new QQ message. And as a further example, a mail application receiving new mail. These applications may only be displayed originally on the second screen. As a further example, the reminder time of the set alarm is already reached.

In this embodiment, the first operation being detected by the first screen means that the user is at a location suitable for viewing the first screen, and with the use of the information processing method described, the first screen may be automatically controlled to display the second window of the specified type of application, which avoids a significant problem that the user does not see the new incoming mails or messages in time due to the incoming mails or messages being displayed on the first screen, causing a time delay in information processing.

### Embodiment 7

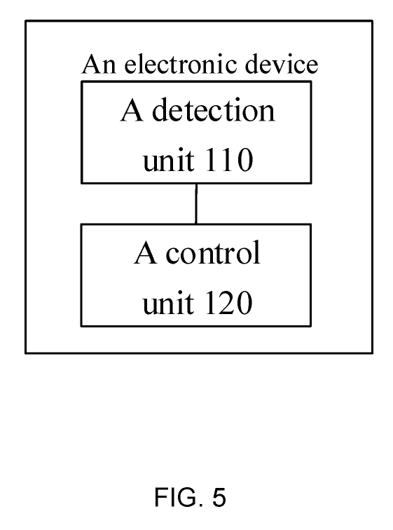

As illustrated in FIG. 5, this embodiment provides an electronic device, comprising: a detection unit 110, configured for detecting a first operation acting on a first screen; and a control unit 120, configured for controlling the first screen to display a first window based on the first operation, wherein the first window is displayed by default or is currently displayed on a second screen, and the first screen is different from the second screen.

The electronic device described in this embodiment can be various terminal devices having information processing, for example, a multi-screen desktop computer, a multi-screen television set-top box, or an electronic device connected with or comprising a plurality of display screens.

The detection unit 110 can be various human-machine interactive interfaces capable of detecting user operations, such as a mouse, a keyboard, and a touch screen. Reference can be made to the forgoing embodiments for detailed content about how to specifically determine direction to the first screen. For example, a touch directly acts on a touch screen that is disposed to be overlapped with the first screen if indicative icons such as a mouse cursor or a keyboard cursor or a floating touch icon are currently displayed on the first screen, it can be considered that the detected operation is directed to the first screen.

The control unit 120 can correspond to a processor or processing circuit of the electronic device. The processor may comprise a central processing unit, a microprocessor, a digital signal processor, an application processor, or a programmable array. The processing circuit may comprise an application specific integrated circuit. In this embodiment, both of the processor and the processing circuit can be an electronic device capable of performing information processing. For example, the control unit can correspond to a host of a desktop computer, and the like.

The control unit 120 controls the first window displayed on the second screen by default or currently displayed on the second screen to be displayed on the first screen, which solves the problem of viewing inconvenience due to the fact that the first window and the first operation are not directed to the same screen.

### Embodiment 8

As illustrated in FIG. 5, this embodiment provides an electronic device, comprising: a detection unit 110, configured for detecting a first operation acting on a first screen; and a control unit 120, configured for controlling the first screen to display a first window based on the first operation, wherein the first window is displayed by default or is currently displayed on a second screen, and the first screen is different from the second screen. The first window is an unopened window and is displayed on the second screen by default; and the first operation is an opening operation of the first window.

In this embodiment, the first window can be a window that is not opened temporarily and is displayed on the second screen by default. The first operation is an opening operation that can trigger the first window to be opened.

In this way, viewing inconvenience caused by the first window being displayed on the second screen by default according to memory information or historical operation information within the device can be avoided.

### Embodiment 9

As illustrated in FIG. 5, this embodiment provides an electronic device, comprising: a detection unit 110, configured for detecting a first operation acting on a first screen; a control unit 120, configured for controlling the first screen to display a first window based on the first operation, wherein the first window is displayed by default or is currently displayed on a second screen, and the first screen is different from the second screen. The first window is a window currently displayed on the second screen; and the control unit 120 is used for, before detecting the first operation acting on the first screen, controlling the first screen to display another first window based on the first operation.

In this embodiment, if one first window is currently displayed on the second screen, the control unit 120 described in this embodiment will control the second screen to display one more first window. In this way, the electronic device can display the same application, the same file or two windows of the same application on two screens.

### Embodiment 10

As illustrated in FIG. 5, this embodiment provides an electronic device, comprising: a detection unit 110, configured for detecting a first operation acting on a first screen; a control unit 120, configured for controlling the first screen to display a first window based on the first operation, wherein the first window is displayed by default or is currently displayed on a second screen, and the first screen is different from the second screen. The first window is a window currently displayed on the second screen. The control unit 120 is specifically used for controlling the first window to switch from the second screen to the first screen for display based on the first operation.

In this embodiment, the control unit 120 will switch the first window displayed on the second screen from the second screen to the first screen for display, in response to the first operation acting on the first screen. When the first window is displayed on the first screen, the second screen stops the displaying of the first window.

The electronic device provided by this embodiment is different from the previous embodiment in which the second screen is directly controlled to open another first window, the control unit 120 of this embodiment will control the first window displayed on the second screen to be switched to the second screen for display, and the second screen will thus stop the displaying of the first window.

### Embodiment 11

As illustrated in FIG. 5, this embodiment provides an electronic device, comprising: a detection unit 110, configured for detecting a first operation acting on a first screen; a control unit 120, configured for controlling the first screen to display a first window based on the first operation, wherein the first window is displayed by default or is currently displayed on a second screen, and the first screen is different from the second screen.

The electronic device further comprises: a first determination unit, configured for determining the second screen displaying the first window and the first screen displaying an indicative icon; a second determination unit, configured for determining whether the first screen and the second screen are the same screen; the detection unit 110 is specifically used for detecting a switching operation acting on the first screen when it is determined that the first screen is different from the second screen; and the control unit 120 is specifically used for controlling the first window to switch from the second screen to the first screen for display based on the first operation.

The first determination unit and the second determination unit described in this embodiment can each correspond to a processor or processing circuit, the structure of which can be seen from the foregoing embodiments. In this embodiment, the provided electronic device may automatically perform the switching between different screens, therefore, avoiding the phenomenon of cumbersome operations, low intelligence of the device and low user satisfaction due to manual dragging of the window by the user.

### Embodiment 12

As illustrated in FIG. 5, this embodiment provides an electronic device, comprising: a detection unit 110, configured for detecting a first operation acting on a first screen; a control unit 120, configured for controlling the first screen to display a first window based on the first operation, wherein the first window is displayed by default or is currently displayed on a second screen, and the first screen is different from the second screen. The detection unit 110 is further used for detecting whether a specified type of application on the second screen satisfies a preset display condition; the control unit 220 is further used for controlling the second window of the specified type of application in an activated state to be displayed on the first screen; the first screen is a screen that displays an indicative icon or the last screen that receives an indication from a user.

In this embodiment, the detection unit 110 can correspond to an information processing structure capable of detecting a display event triggered by other electronic devices or built-in instructions of an electronic device. If the triggering of the display event indicates that this specified type of application satisfies the preset display conditions, the control unit 120 will control the second window to be displayed on the first screen, facilitating timely viewing of corresponding information by the user.

A specific example is provided hereinafter in combination with any of the above-described embodiments.

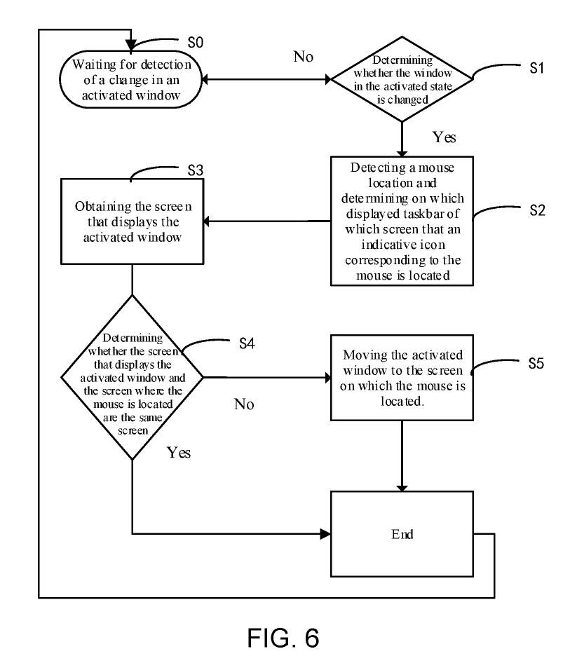

As illustrated in FIG. 6, this example provides an information processing method, comprising the following steps:

Step S0: waiting for detection of a change in an activated window; for example, the detection is performed at preset time intervals, and if the waiting time in this example is the time between the intervals, then the detection awaits the change in the activated window.

Step S1: determining whether the window in the activated state is changed, and if so, the method proceeds to step S2. If not, the method returns back to step S0 and continues waiting.

Step S2: detecting a mouse location and determining on which displayed taskbar of which screen that an indicative icon corresponding to the mouse is located. In this embodiment, the screen that displays the indicative icon can be considered as the screen on which the mouse is located.

Step S3: obtaining the screen that displays the activated window;

Step S4: determining whether the screen that displays the activated window and the screen where the mouse is located are the same screen, and if so, the process ends and returns to step S0. If not, the method proceeds to step S5.

Step S5: moving the activated window to the screen on which the mouse is located.

In the several embodiments provided in the present application, it should be understood that the disclosed device and method may be practiced in other manners. The device embodiments described above are merely illustrative. For example, the division of units is merely a division based on logical functions and there may be other ways of division in real practice. For example, multiple units or components may be combined, or may be integrated into another system, or some features can be omitted or not performed. Additionally, coupling, direct coupling, or communication connections among the component parts as shown or discussed may be implemented through some interface(s), and indirect coupling or communication connections of devices or units may be in electrical, mechanical, or other forms.

The above-described units used as separate components may be or may not be physically independent of each other. The components illustrated as a unit may be or may not be a physical unit, that is be either located at a position or deployed on a plurality of network units. A part or all of the units may be selected according to actual needs to achieve the objectives of the solutions of the embodiments.

Furthermore, in various embodiments of the present invention, the functional units can be integrated in one processing module, or may exist as a single unit, or two or more units may be integrated in one unit. The aforementioned integrated units may be implemented in the form of hardware, or may also be implemented in the form of a hardware-plus-software functional unit.

A person skilled in the art should understand that all or part of the steps for realizing the method embodiments described above may be accomplished by program instruction relevant hardware. The aforementioned program may be stored in a computer readable storage medium. When the program is executed, the steps of the method embodiments described above are performed. The aforementioned storage medium includes various media capable of storing program codes, such as a mobile storage device, a Read-Only Memory (ROM), a Random Access Memory (RAM), a magnetic disk, an optical disk, or the like.

The above are only specific embodiments of the present invention, and the protection scope of the present disclosure is not limited thereto. It will readily occur to those skilled in the art, within the technical scope disclosed by the present invention, that changes or substitutions shall fall within the protect scope of the present invention. Accordingly, the protection scope of the present invention is defined by the claims.

1. A method, comprising:
detecting, using a processor, a first user operation upon one of a plurality of displays operative connected to an information handling device; and
controlling, using a processor, the one of a plurality of displays to display thereupon a first window associated with the first user operation;
wherein the first user operation may be performed upon any of the plurality of displays.

2. The method according to claim 1, wherein:
the first window comprises an unopened window displayed on another display of the plurality of displays; and
the first user operation comprises an opening operation for the first window.

3. The method according to claim 1, wherein:
the first window comprises a window currently displayed on another display of the plurality of displays; and
controlling, using a processor, the one of a plurality of displays to display a first window based on the first user operation; and
controlling, using a processor, the one of a plurality of displays to display a second first window based on the first user operation.

4. The method according to claim 1, wherein:
the first window is a window currently displayed on another of the plurality of displays;
controlling, using a processor, the one of a plurality of displays to display a first window based on the first user operation and;
controlling, using a processor, the first window to switch from another of the plurality of displays to the one of a plurality of displays for display based on the first user operation.

5. The method according to claim 1, wherein before detecting the first user operation upon the one of a plurality of displays, the method further comprises:
determining, using a processor, another of the plurality of displays displaying the first window and the one of a plurality of displays displaying an indicative icon;
determining, using a processor, whether the one of a plurality of displays and the another of the plurality of displays are displaying substantially the same content;
detecting, using a processor, the first user operation upon the one of a plurality of displays;
detecting, using a processor, a switching operation acting on the one of a plurality of displays when it is determined that the one of a plurality of displays is displaying content different from content displayed by the another of the plurality of displays;
displaying, using a processor, the first window on the one of a plurality of displays based on the first user operation;
controlling, using a processor, the first window to switch from the another of a plurality of displays to the one of a plurality of displays for display based on the first user operation.

6. The method according to claim 1, wherein the method further comprises:
detecting, using a processor, whether a specified type of application on another of the plurality of displays satisfies a preset display condition;
controlling, using a processor, a second window of the specified type of application satisfying the preset display condition to be displayed on the one of a plurality of displays, wherein the one of a plurality of displays is a display that displays an indicative device icon or the last screen that receives an indication from a user.

7. The method according to claim 2, wherein the method further comprises:
detecting, using a processor, whether a specified type of application on the another of a plurality of displays satisfies a preset display condition;
controlling, using a processor, a second window of the specified type of application satisfying the preset display condition to be displayed on the one of a plurality of displays, wherein the one of a plurality of displays is a display that displays an indicative device icon or the last screen that receives an indication from a user.

8. The method according to claim 3, wherein the method further comprises:
detecting, using a processor, whether a specified type of application on the another of a plurality of displays satisfies a preset display condition;
controlling, using a processor, the second window of the specified type of application satisfying the preset display condition to be displayed on the one of a plurality of displays, wherein the one of a plurality of displays is a display that displays an indicative device icon or the last screen that receives an indication from a user.

9. The method according to claim 4, wherein the method further comprises:
detecting, suing a processor, whether a specified type of application on the another of a plurality of displays satisfies a preset display condition;
controlling, using a processor, the second window of the specified type of application satisfying the preset display condition to be displayed on the one of a plurality of displays, wherein the one of a plurality of displays is a display that displays an indicative device icon or the last screen that receives an indication from a user.

10. The method according to claim 5, wherein the method further comprises:
detecting, using a processor, whether a specified type of application on the another of a plurality of displays satisfies a preset display condition;
controlling, using a processor, the second window of the specified type of application satisfying the preset display condition to be displayed on the one of a plurality of displays, wherein the one of a plurality of displays is a display that displays an indicative device icon or the last screen that receives an indication from a user.

11. An electronic device, comprising:
a detection unit that detects a first user operation acting upon one of a plurality of displays operatively connected to the electronic device; and
a control unit that controls the one of a plurality of display to display a first window based on the first user operation;
wherein the first user operation may be performed upon any of the plurality of displays.

12. The electronic device according to claim 11, wherein
the first window comprises an unopened window displayed on another of a plurality of displays;
the first user operation comprises an opening operation for the first window.

13. The electronic device according to claim 11, wherein
the first window comprises a window currently displayed on another of the plurality of displays;
the control unit detects the first user operation acting upon the one of a plurality of displays and controls the one of a plurality of displays to display another first window based on the first user operation.

14. The electronic device according to claim 13, wherein
the first window comprises a window currently displayed on another of the plurality of displays;
the control unit specifically controls the first window to switch from another of the plurality of displays to the one of a plurality of displays for display based on the first user operation.

15. The electronic device according to claim 11, wherein the electronic device further comprises:
a first determination unit that determines another of the plurality of displays is displaying the first window and the one of the plurality of displays is displaying an indicative icon;
a second determination unit that determines whether the one of the plurality of displays and another of the plurality of displays are displaying substantially the same content;
wherein the detection unit is specifically used to detect a switching operation acting on the one of the plurality of displays when it is determined that the one of the plurality of displays is not displaying substantially the same content as another one of the plurality of displays; and
wherein the control unit is specifically used to control the first window to switch from another one of the plurality of displays to the one of the plurality of displays based on the first user operation.

16. The electronic device according claim 11, wherein
the detection unit further detects whether a specified type of application on the another of the plurality of displays satisfies a preset display condition;
the control unit further controls the second window of the specified type of application in an activated state displayed on the one of the plurality of displays and the one of the plurality of displays displays an indicative icon or the last display that receives an indication from a user.

17. The electronic device according claim 12, wherein
the detection unit further detects whether a specified type of application on the another of a plurality of displays satisfies a preset display condition;
the control unit further controls the second window of the specified type of application in an activated state displayed unit on the one of a plurality of displays and the one of a plurality of displays displays an indicative icon or the last display that receives an indication from a user.

18. The electronic device according claim 13, wherein
the detection unit further detects whether a specified type of application on the another of the plurality of displays satisfies a preset display condition;
the control unit further controls the second window of the specified type of application in an activated state displayed on the one of a plurality of displays and the one of a plurality of displays displays an indicative icon or the last display that receives an indication from a user.

19. The electronic device according claim 14, wherein
the detection unit further detects whether a specified type of application on the another of the plurality of displays satisfies a preset display condition;
the control unit further controls the second window of the specified type of application in an activated state displayed on the one of a plurality of displays and the one of a plurality of displays displays an indicative icon or the last display that receives an indication from a user.

20. The electronic device according claim 15, wherein
the detection unit further detects whether a specified type of application on the another of the plurality of displays satisfies a preset display condition;
the control unit further controls the second window of the specified type of application in an activated state displayed on the one of a plurality of displays and the one of a plurality of displays displays an indicative icon or the last screen that receives an indication from a user.
